(19) United States
(12) Patent Application Publication
(10) Pub. No.: US 2026/0141703 A1
(43) Pub. Date: May 21, 2026

(54) METHOD FOR PERFORMING A TASK ACCORDING TO A FLARE MODEL INCLUDING A MULTI-MODAL PLANNING MODULE AND AN ENVIRONMENT-ADAPTIVE REPLANNING MODULE AND AI AGENT USING THE SAME

(71) Applicants: Seoul National University R&DB Foundation, Seoul (KR); UIF (University Industry Foundation), Yonsei University, Seoul (KR)

(72) Inventors: Tae Woong KIM, Gwacheon-si (KR); Byeonghwi KIM, Seoul (KR); Jonghyun CHOI, Seoul (KR)

(21) Appl. No.: 18/985,829

(22) Filed: Dec. 18, 2024

(30) Foreign Application Priority Data
Nov. 20, 2024 (KR) 10-2024-0166732

(51) Int. Cl. G06V 10/82; G06V 10/74; G06V 10/771

(52) U.S. Cl. CPC G06V 10/82; G06V 10/761; G06V 10/771

(57) ABSTRACT

A method for performing a task according a FLARE model including a multi-modal planning module and an environment-adaptive replanning module is provided. The method of an AI agent includes steps of: (a) instructing the multi-modal planning module to calculate degrees of similarity between training data and a current pair comprised of natural language data and image data and acquire k natural language data by using the degrees of similarity; (b) instructing the multi-modal planning module to generate an initial action plan by using the k natural language data; and (c) if a target required to perform a sub-goal is not detected from egocentric-recognizing information, instructing the environment-adaptive replanning module to select a candidate target having a highest similarity to the target among candidate targets and generate a revised sub-goal by using the candidate target, and perform the sub-goal by using the revised sub-goal.

### CROSS REFERENCE OF RELATED APPLICATION

This present application claims the benefit of the earlier filing date of Korean non-provisional patent application No. 10-2024-0166732, filed on Nov. 20, 2024, the entire contents of which being incorporated herein by reference.

### FIELD OF THE DISCLOSURE

The present disclosure relates to a method for performing at least one task according to a FLARE (Few-shot Language with environmental Adaptive Replanning Embodied agent) model including a multi-modal planning module and an environment-adaptive replanning module and an AI agent using the same.

### BACKGROUND OF THE DISCLOSURE

An AI robot which can handle annoying tasks such as house works completely by understanding natural language instructions related to human intentions is what we all want. In order for the AI robot to handle the annoying tasks on behalf of a person, it should be able to establish a series of detailed and sequential task plans for carrying out the natural language instructions. Also, it should be able to recognize and interact with one or more objects in a 3D environment. Going one step further, it would be ideal if the AI robot could navigate to find the objects according to the natural language instructions based on egocentric-recognizing information, interact with the objects, and perform long-term tasks.

Although there were attempts for conventional AI robots to find the objects located within the surrounding area thereof and interact with the objects according to the natural language instructions, the conventional AI robots have a problem in that they try to find and interact with a target object only not located in the surrounding area, even if another object similar to the target object is located within the surrounding area, while they perform specific tasks of the long-term tasks. Accordingly, the problem prevents the conventional AI robots from completing the specific tasks.

Further, when the natural language instructions are inputted, the conventional AI robots draw inferences from the natural language instructions and massive training data stored in a training data set, but they have other problems in that it takes too much time to draw the inferences and has a high probability of generating incorrect detailed task plans.

Accordingly, it is necessary to invent a method of an AI agent for solving these problems.

### SUMMARY OF THE DISCLOSURE

It is an object of the present disclosure to solve all the aforementioned problems.

It is another object of the present disclosure to instruct a multi-modal planning module to (i) select z training data from a plurality of training data stored in a training data set, wherein each of the training data is comprised of each of natural language instructing data for training and each of surrounding image data for training, (ii) calculate degrees of similarity between each of the selected z training data and a current pair comprised of current natural language instructing data and current surrounding image data, (iii) determine k training data having TOP k degrees of similarity to the current pair among the selected z training data, (iv) acquire k natural language instructing data for training included in the k training data, and (v) generate an initial action plan, including a 1_st sub-goal to an n_th sub-goal, to be used for performing a current task by using the k natural language instructing data for training.

It is still another object of the present disclosure to (i) establish at least one subsequent action plan for an i_th sub-goal by referring to i_th egocentric-recognizing information and a semantic map corresponding to a surrounding area, wherein the i_th egocentric-recognizing information is acquired by analyzing i_th egocentric-image data, (ii) perform the i_th sub-goal according to the subsequent action plan, wherein, in case a specific target required to perform a specific sub-goal which is at least one of the i_th sub-goal is not detected from specific egocentric-recognizing information, the AI agent selects a specific candidate target having a highest similarity to the specific target among candidate targets, and generates a revised sub-goal which is revised from the specific sub-goal by using the specific candidate target, and (iii) allow the specific sub-goal to be performed by using the revised sub-goal.

In accordance with one aspect of the present disclosure, there is provided a method for performing at least one task according to a FLARE model including a multi-modal planning module and an environment-adaptive replanning module, including steps of: (a) in response to acquiring current natural language instructing data to be used for performing a current task, (i) collecting, by an AI agent, current surrounding image data from a surrounding area of the AI agent and (ii) instructing, by the AI agent, the multi-modal planning module to (ii_1) select z training data from a plurality of training data stored in a training data set, wherein the z is an integer greater than or equal to 1, wherein each of the training data includes each of natural language instructing data for training and each of surrounding image data for training, (ii_2) calculate degrees of similarity between each of the selected z training data and a current pair comprised of the current natural language instructing data and the current surrounding image data, (ii_3) determine k training data having TOP k degrees of similarity to the current pair among the selected z training data, wherein the k is an integer greater than or equal to 1 and less than or equal to the z, and (ii_4) acquire k natural language instructing data for training included in the k training data; (b) instructing, by the AI agent, the multi-modal planning module to generate an initial action plan, including a 1_st sub-goal to an n_th sub-goal, to be used for performing the current task by using the k natural language instructing data for training; and (c) (i) establishing, by the AI agent, at least one subsequent action plan for an i_th sub-goal by referring to i_th egocentric-recognizing information and a semantic map corresponding to the surrounding area, wherein the i is an integer of from 1 to the n, wherein the i_th egocentric-recognizing information is acquired by analyzing i_th egocentric-image data that is image data taken from a current viewing angle of the AI agent during performing the i_th sub-goal, (ii) performing, by the AI agent, the i_th sub-goal according to the subsequent action plan, wherein, in case a specific target required to perform a specific sub-goal is not detected from specific egocentric-recognizing information, the AI agent selects a specific candidate target having a highest similarity to the specific target among candidate targets, wherein the specific sub-goal is at least one sub-goal among the i_th sub-goal, and generates a revised sub-goal which is revised from the specific sub-goal by using the specific candidate target, and (iii) allowing, by the AI agent, the specific sub-goal to be performed by using the revised sub-goal.

As one example, at the step of (c), the AI agent selects the candidate targets by referring to the specific egocentric-recognizing information and multiple pieces of previous egocentric-recognizing information, wherein the multiple pieces of the previous egocentric-recognizing information are acquired before the AI agent performs the specific sub-goal, and wherein the candidate targets are multiple pieces of information on objects recognized as being located within the surrounding area.

As one example, at the step of (c), the AI agent instructs the environment-adaptive replanning module to (i) perform text embedding on a specific name of the specific target and each of candidate names corresponding to each of the candidate targets by using a text encoder, thereby generating an embedded specific name and each of embedded candidate names, (ii) calculate degrees of similarity between the embedded specific name and each of the embedded candidate names, and (iii) select the specific candidate target having a highest degree of similarity to the specific target by referring to the degrees of similarity between the embedded specific name and each of the embedded candidate names.

As one example, at the step of (a), the AI agent instructs the multi-modal planning module to (i) execute a 1_st sub-process of (i_1) performing text embedding on the current natural language instructing data and each of z natural language instructing data for training included in each of the z training data by using a text encoder, thereby generating embedded current natural language instructing data and each of embedded z natural language instructing data for training and (i_2) calculating 1_st degrees of cosine similarity between the embedded current natural language instructing data and each of the embedded z natural language instructing data for training, (ii) execute a 2_nd sub-process of (ii_1) performing image embedding on the current surrounding image data and each of z surrounding image data for training included in each of the z training data by using an image encoder, thereby generating embedded current surrounding image data and each of embedded z surrounding image data for training and (ii_2) calculating 2_nd degrees of cosine similarity between the embedded current surrounding image data and each of the embedded z surrounding image data for training, and (iii) generate the degrees of similarity between each of the selected z training data and the current pair by calculating degrees of multi-modal similarity, wherein the degrees of multi-modal similarity are acquired by applying each of weights to each of the 1_st degrees of cosine similarity and the 2_nd degrees of cosine similarity and then by normalizing 1_st weighted degrees of cosine similarity and 2_nd weighted degrees of cosine similarity.

As one example, at the step of (b), the AI agent instructs the multi-modal planning module to (i) generate a prompt including at least one main-goal corresponding to the current natural language instructing data by referring to the k natural language instructing data for training and an expert daemon, (ii) transmit the prompt to a large language model (LLM), thereby allowing the prompt to go through in-context learning by the large language model, and (iii) generate the 1_st sub-goal to the n_th sub-goal by repeating a sub-process of inserting at least some of an i_th sub-goal action, a 1_i-th sub-goal target, and a 2_i-th sub-goal target into an i_th sub-goal frame to thereby generate the i_th sub-goal, wherein the i_th sub-goal frame is configured to include a sub-goal action holder, a 1_st sub-goal target holder, and a 2_nd sub-goal target holder, wherein the i_th sub-goal action for performing an i_th sub-action plan corresponding to the i_th sub-goal is capable of being inserted into the sub-goal action holder, and wherein the 1_i-th sub-goal target and the 2_i-th sub-goal target for performing the i_th sub-action plan are capable of being inserted into each of the 1_st sub-goal target holder and the 2_nd sub-goal target holder.

In accordance with another aspect of the present disclosure, there is provided an AI agent for performing at least one task according to a FLARE model including a multi-modal planning module and an environment-adaptive replanning module, including: at least one memory that stores instructions; and at least one processor configured to execute the instructions to perform processes of: (I) in response to acquiring current natural language instructing data to be used for performing a current task, (i) collecting current surrounding image data from a surrounding area of the AI agent and (ii) instructing the multi-modal planning module to (ii_1) select z training data from a plurality of training data stored in a training data set, wherein the z is an integer greater than or equal to 1, wherein each of the training data includes each of natural language instructing data for training and each of surrounding image data for training, (ii_2) calculate degrees of similarity between each of the selected z training data and a current pair comprised of the current natural language instructing data and the current surrounding image data, (ii_3) determine k training data having TOP k degrees of similarity to the current pair among the selected z training data, wherein the k is an integer greater than or equal to 1 and less than or equal to the z, and (ii_4) acquire k natural language instructing data for training included in the k training data; (II) instructing the multi-modal planning module to generate an initial action plan, including a 1_st sub-goal to an n_th sub-goal, to be used for performing the current task by using the k natural language instructing data for training; and (III) (i) establishing at least one subsequent action plan for an i_th sub-goal by referring to i_th egocentric-recognizing information and a semantic map corresponding to the surrounding area, wherein the i is an integer of from 1 to the n, wherein the i_th egocentric-recognizing information is acquired by analyzing i_th egocentric-image data that is image data taken from a current viewing angle of the AI agent during performing the i_th sub-goal, (ii) performing the i_th sub-goal according to the subsequent action plan, wherein, in case a specific target required to perform a specific sub-goal is not detected from specific egocentric-recognizing information, the processor selects a specific candidate target having a highest similarity to the specific target among candidate targets, wherein the specific sub-goal is at least one sub-goal among the i_th sub-goal, and the processor generates a revised sub-goal which is revised from the specific sub-goal by using the specific candidate target, and (iii) allowing the specific sub-goal to be performed by using the revised sub-goal.

As one example, at the process of (III), the processor selects the candidate targets by referring to the specific egocentric-recognizing information and multiple pieces of previous egocentric-recognizing information, wherein the multiple pieces of the previous egocentric-recognizing information are acquired before the AI agent performs the specific sub-goal, and wherein the candidate targets are multiple pieces of information on objects recognized as being located within the surrounding area.

As one example, at the process of (III), the processor instructs the environment-adaptive replanning module to (i) perform text embedding on a specific name of the specific target and each of candidate names corresponding to each of the candidate targets by using a text encoder, thereby generating an embedded specific name and each of embedded candidate names, (ii) calculate degrees of similarity between the embedded specific name and each of the embedded candidate names, and (iii) select the specific candidate target having a highest degree of similarity to the specific target by referring to the degrees of similarity between the embedded specific name and each of the embedded candidate names.

As one example, at the process of (I), the processor instructs the multi-modal planning module to (i) execute a 1_st sub-process of (i_1) performing text embedding on the current natural language instructing data and each of z natural language instructing data for training included in each of the z training data by using a text encoder, thereby generating embedded current natural language instructing data and each of embedded z natural language instructing data for training and (i_2) calculating 1_st degrees of cosine similarity between the embedded current natural language instructing data and each of the embedded z natural language instructing data for training, (ii) execute a 2_nd sub-process of (ii_1) performing image embedding on the current surrounding image data and each of z surrounding image data for training included in each of the z training data by using an image encoder, thereby generating embedded current surrounding image data and each of embedded z surrounding image data for training and (ii_2) calculating 2_nd degrees of cosine similarity between the embedded current surrounding image data and each of the embedded z surrounding image data for training, and (iii) generate the degrees of similarity between each of the selected z training data and the current pair by calculating degrees of multi-modal similarity, wherein the degrees of multi-modal similarity are acquired by applying each of weights to each of the 1_st degrees of cosine similarity and the 2_nd degrees of cosine similarity and then by normalizing 1_st weighted degrees of cosine similarity and 2_nd weighted degrees of cosine similarity.

As one example, at the process of (II), the processor instructs the multi-modal planning module to (i) generate a prompt including at least one main-goal corresponding to the current natural language instructing data by referring to the k natural language instructing data for training and an expert daemon, (ii) transmit the prompt to a large language model (LLM), thereby allowing the prompt to go through in-context learning by the large language model, and (iii) generate the 1_st sub-goal to the n_th sub-goal by repeating a sub-process of inserting at least some of an i_th sub-goal action, a 1_i-th sub-goal target, and a 2_i-th sub-goal target into an i_th sub-goal frame to thereby generate the i_th sub-goal, wherein the i_th sub-goal frame is configured to include a sub-goal action holder, a 1_st sub-goal target holder, and a 2_nd sub-goal target holder, wherein the i_th sub-goal action for performing an i_th sub-action plan corresponding to the i_th sub-goal is capable of being inserted into the sub-goal action holder, and wherein the 1_i-th sub-goal target and the 2_i-th sub-goal target for performing the i_th sub-action plan are capable of being inserted into each of the 1_st sub-goal target holder and the 2_nd sub-goal target holder.

### BRIEF DESCRIPTION OF THE DRAWINGS

The above and other objects and features of the present disclosure will become apparent from the following description of preferred embodiments given in conjunction with the accompanying drawings.

The following drawings to be used to explain example embodiments of the present disclosure are only part of example embodiments of the present disclosure and other drawings can be obtained based on the drawings by those skilled in the art of the present disclosure without inventive work.

FIG. 1 is a drawing schematically illustrating a configuration of an AI agent according to a FLARE model including a multi-modal planning module and an environment-adaptive replanning module in accordance with one example embodiment of the present disclosure.

FIG. 2 is a flow chart schematically illustrating a method for performing at least one task by an AI agent according to the FLARE model including the multi-modal planning module and the environment-adaptive replanning module in accordance with one example embodiment of the present disclosure.

FIG. 3 is a drawing schematically illustrating a whole configuration of the FLARE model including the multi-modal planning module and the environment-adaptive replanning module in accordance with one example embodiment of the present disclosure.

FIG. 4 is a drawing schematically illustrating a detailed configuration of the multi-modal planning module, and processes of generating an initial action plan including a plurality of sub-goals to be used for performing a current task.

FIG. 5 is a drawing schematically illustrating a detailed configuration of the environment-adaptive replanning module, and processes of selecting a specific candidate target having a highest similarity to a specific target among candidate targets and generating a revised sub-goal which is revised from a specific sub-goal by using the specific candidate target.

### DETAILED DESCRIPTION OF THE PREFERRED EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the present invention, although different, are not necessarily mutually exclusive. For example, a particular feature, structure, or characteristic described herein in connection with one embodiment may be implemented within other embodiments without departing from the spirit and scope of the present invention.

In addition, it is to be understood that the position or arrangement of individual elements within each disclosed embodiment may be modified without departing from the spirit and scope of the present invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

To allow those skilled in the art to carry out the present invention easily, the example embodiments of the present invention by referring to attached diagrams will be explained in detail as shown below.

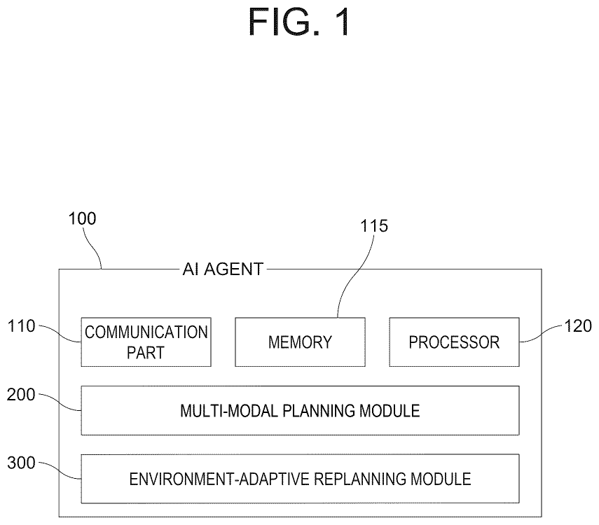

FIG. 1 is a drawing schematically illustrating a configuration of an AI agent 100 according to a FLARE model including a multi-modal planning module 200 and an environment-adaptive replanning module 300 in accordance with one example embodiment of the present disclosure.

By referring to FIG. 1, the AI agent 100 may include the multi-modal planning module 200 and the environment-adaptive replanning module 300. Herein, processes of input/output and computations of the multi-modal planning module 200 and the environment-adaptive replannning module 300 may be respectively performed by a communication part 110 and a processor 120. However, detailed explanation on communications between the communication part 110 and the processor 120 is omitted in FIG. 1. Further, a memory 115 may have stored various instructions to be described later, and the processor 120 may execute the instructions stored in the memory 115 and may execute the instructions to be described later. However, the present disclosure does not exclude a case where it includes an integrated processor in which a medium, a processor, and a memory are integrated.

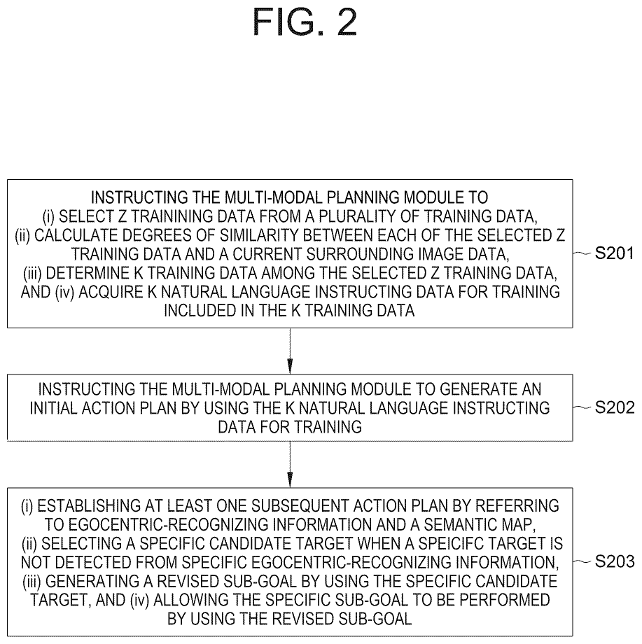

Next, a method of the AI agent 100 for performing at least one task in accordance with one example embodiment of the present disclosure is explained in more detail by referring to FIG. 2 below.

FIG. 2 is a flow chart schematically illustrating the method for performing at least one task by the AI agent 100 according to the FLARE model including the multi-modal planning module 200 and the environment-adaptive replanning module 300 in accordance with one example embodiment of the present disclosure.

By referring to FIG. 2, at a step of S201, in response to acquiring current natural language instructing data to be used for performing a current task, the AI agent 100 may (i) collect current surrounding image data from a surrounding area thereof and (ii) instruct the multi-modal planning module 200 to (ii_1) select z training data from a plurality of training data stored in a training data set, (ii_2) calculate degrees of similarity between each of the selected z training data and a current pair comprised of the current natural language instructing data and the current surrounding image data, (ii_3) determine k training data having TOP k degrees of similarity to the current pair among the selected z training data, and (ii_4) acquire k natural language instructing data for training included in the k training data.

Herein, each of the training data includes each of natural language instructing data for training and each of surrounding image data for training. Further, the z is an interger greater than or equal to 1 and the k is an integer greater than or equal to 1 and less than or equal to the z.

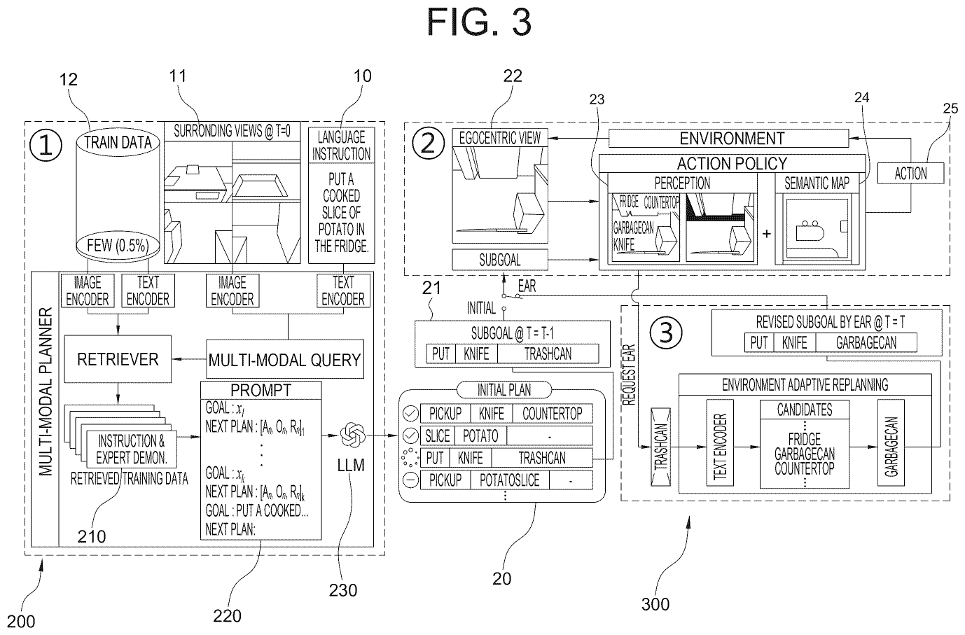

In order to explain the step of S201 in more detail, FIG. 3 can be referred to.

FIG. 3 is a drawing schematically illustrating a whole configuration of the FLARE model including the multi-modal planning module 200 and the environment-adaptive replanning module 300 in accordance with one example embodiment of the present disclosure.

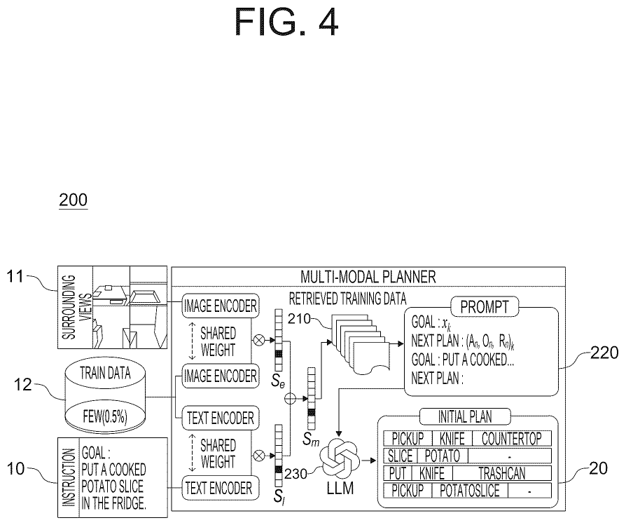

By referring to FIG. 3, the AI agent 100 may collect current surrounding image data 11 from a surrounding area in response to acquiring current natural language instructing data 10 (e.g., “Put a cooked slice of potato in the fridge”) to be used for performing a current task. Herein, the current surrounding image data 11 may be illustrated as a total of four sheets (e.g., a front view image data, a left view image data, a rear view image data, and a right view image data), but the scope of the present disclosure is not limited thereto. And then, in response to acquiring the current natural language instructing data 10 and the current surrounding image data 11, the AI agent 100 instructs the multi-modal planning module 200 to select z training data 12 (e.g., few data corresponding to about 0.5% of all training data) from all the training data stored in the training data set and calculate degrees of similarity between each of the selected z training data and the current pair comprised of the current natural language instructing data 10 and the current surrounding image data 11. Herein, in order to explain the method of calculating the degrees of similarity between each of the selected z training data and the current pair in more detail, FIG. 4 can be referred to.

FIG. 4 is a drawing schematically illustrating a detailed configuration of the multi-modal planning module 200, and processes of generating an initial action plan 20 including a plurality of sub-goals to be used for performing a current task.

By referring to FIG. 4, the AI agent 100 may instruct the multi-modal planning module 200 to perform text embedding on the current natural language instructing data 10 and each of z natural language instructing data for training included in each of the z training data 12 by using a text encoder, thereby generating embedded current natural language instructing data and each of embedded z natural language instructing data for training.

As one example, the multi-modal planning module 200 may select multiple pieces of 1_st text data from the current natural language instructing data 10 (e.g., “Put a cooked slice of potato in the fridge”) and perform text embedding on the multiple pieces of 1_st text data within a 1_st vector space, by using the text encoder, thereby generating the embedded current natural language instructing data. Similarly, the multi-modal planning module 200 may select multiple pieces of 2_nd text data from each of the z natural language instructing data for training and perform text embedding on the multiple pieces of 2_nd text data within the 1_st vector space, by using the text encoder, thereby generating each of the embedded z natural language instructing data for training. Then, the multi-modal planning module 200 may calculate 1_st degrees of cosine similarity between the embedded current natural language instructing data and each of the embedded z natural language instructing data for training. Herein, the 1_st degrees of cosine similarity Sₗ can be defined as follows:

$${S}_{l} = \{ {s}_{l , 1} , {s}_{l , 2} , ⋯ {s}_{l , N} \}$$

Herein, S_{l,j} may denote degrees of cosine similarity between the current task and a task for training of an i_th training data set, and the i is an integer of from 1 to the N. Meanwhile, since a method of calculating the degrees of cosine similarity between two text embedding vectors (i.e., two different embedded text data) is well known to those skilled in the art, explanation thereon will be omitted.

As another example, the multi-modal planning module 200 may select multiple pieces of 1_st image data from the current surrounding image data 11 and perform image embedding on the multiple pieces of 1_st image data within a 2_nd vector space, by using the image encoder, thereby generating the embedded current surrounding image data. Similarly, the multi-modal planning module 200 may select multiple pieces of 2_nd image data from each of the z surrounding image data for training and perform image embedding on the multiple pieces of 2_nd image data within the 2_nd vector space, by using the image encoder, thereby generating each of the embedded z surrounding image data for training. Then, the multi-modal planning module 200 may calculate 2_nd degrees of cosine similarity between the embedded current surrounding image data and each of the embedded z surrounding image data for training. Herein, the 2_nd degrees of cosine similarity Sₑ can be defined as follows:

$${S}_{e} = \{ {s}_{e , 1} , {s}_{e , 2} , ⋯ {s}_{e , N} \}$$

Herein, S_{e,i} may denote degrees of cosine similarity between the current task and the task for training of the i_th training data set, and the i is an integer of from 1 to the N. Meanwhile, since a method of calculating the degrees of cosine similarity between two image embedding vectors (i.e., two different embedded image data) is also well known to those skilled in the art, explanation thereon will be omitted.

Next, the AI agent 100 may instruct the multi-modal planning module 200 to generate the degrees of similarity between each of the selected z training data and said current pair by calculating degrees of multi-modal similarity. In this case, the degrees of multi-modal similarity may be acquired by applying each of weights to each of the 1_st degrees of cosine similarity and the 2_nd degrees of cosine similarity and then by normalizing 1_st weighted degrees of cosine similarity and 2_nd weighted degrees of cosine similarity. Herein, the multi-modal similarity Sₘ can be defined as follows:

$${S}_{m} = {w}_{l} \cdot \frac{{s}_{l}}{{Σ}_{i = 1}^{N} {s}_{l , i}} + {w}_{e} \cdot \frac{{s}_{e}}{{Σ}_{i = 1}^{N} {s}_{e , i}}$$

Herein, wᵢ may denote a 1_st weight applied to the 1_st degrees of cosine similarity Sₗ and wₑ may denote a 2_nd weight applied to the 2_nd degrees of cosine similarity Sₑ. In this case, the 1_st weight and the 2_nd weight may have different values, but they may have the same value as the case may be. Said calculated degrees of multi-modal similarity Sₘ may be used to obtain data for generating prompts, and a detailed description thereon is as follows.

By referring back to the step of S201 and FIG. 3, the AI agent 100 may instruct the multi-modal planning module 200 to determine k training data having TOP k degrees of similarity to the current natural language instructing data 10 and the current surrounding image data 11 among the selected z training data by referring to the calculated degrees of multi-modal similarity Sₘ. Herein, the k is an integer greater than or equal to 1 and less than or equal to the z. Further, the AI agent 100 may instruct the multi-modal planning module 200 to acquire k natural language instructing data for training included in the k training data 210.

Next, at a step of S202, the AI agent 100 may instruct the multi-modal planning module 200 to generate an initial action plan 20, including a 1_st sub-goal to an n_th sub-goal, to be used for performing the current task by using the k natural language instructing data for training.

More specifically, the AI agent 100 may instruct the multi-modal planning module 200 to generate a prompt 220 including at least one main-goal corresponding to the current natural language instructing data 10 by referring to the k natural language instructing data for training included in the k training data 210 and an expert daemon. In this case, it is desirable that the expert daemon is at least one example data for generating the prompt 220, which is similar to the current natural language instructing data 10 obtained from a predetermined system or at least one user, and it is desirable that the prompt 220 is a few-shot prompt. Further, the AI agent 100 may instruct the multi-modal planning module 200 to transmit the prompt 220 to a large language model 230 (LLM), thereby allowing the prompt 220 to go through in-context learning by the large language model 230. And then, the initial action plan 20, including the 1_st sub-goal to the n_th sub-goal, to be used for performing the current task is generated by the multi-modal planning module 200. Herein, each of the 1_st sub-goal to the n_th sub-goal can be defined as follows:

$${S}_{i} = ( {A}_{i} , {O}_{i} , {R}_{i} )$$

Herein, Sᵢ may denote an i_th sub-goal and Aᵢ may denote i_th sub-goal action for performing an i_th sub-action plan corresponding to the i_th sub-goal, and each of Oᵢ and Rᵢ may denote a 1_i-th sub-goal target and a 2_i-th sub-goal target for performing the i_th sub-action plan. In this case, the i is an integer of from 1 to the N.

For example, in response to determining the i_th sub-goal as a “Pick up a Knife located on the CounterTop”, the multi-modal planning module 200 may (i) insert the i_th sub-goal action (i.e., “Pickup”) for performing the i_th sub-action plan corresponding to the i_th sub-goal into a sub-goal action holder and (ii) insert the 1_i-th sub-goal target (i.e., “Knife”) for performing the i_th sub-action plan into a 1_st sub-goal target holder, and (iii) insert the 2_i-th sub-goal target (i.e., “CounterTop”) for performing the i_th sub-action plan into a 2_nd sub-goal target holder, thereby generating the i_th sub-goal like Sᵢ=(Pickup, Knife, CounterTop).

Meanwhile, although it has been explained that the i_th sub-goal action (i.e., “Pickup”) is firstly inserted into the sub-goal action holder to generate the i_th sub-goal, but the scope of the present disclosure is not limited thereto. In some cases, either the 1_i-th sub-goal target (i.e., “Knife”) or the 2_i-th sub-goal target (i.e., “CounterTop”) may be firstly inserted into the 1_st sub-goal target holder or the 2_nd sub-goal target holder, while in other cases each of the i_th sub-goal action, the 1_i-th sub-goal target, and 2_i-th sub-goal target may be simultaneously inserted into each of the sub-goal action holder, the 1_st sub-goal target holder, and the 2_nd sub-goal target holder.

Further, the multi-modal planning module 200 in accordance with the present disclosure may generate the 1_st sub-goal to the n_th sub-goal and thus generate the initial action plan 20 by repeating each sub-process of inserting the i_th sub-goal action, the 1_i-th sub-goal target, and the 2_i-th sub-goal target into the i_th sub-goal frame.

Next, at a step of S203, the AI agent 100 may establish at least one subsequent action plan for the i_th sub-goal by referring to i_th egocentric-recognizing information and a semantic map corresponding to the surrounding area. Herein, the i_th egocentric-recognizing information is acquired by analyzing i_th egocentric-image data that is image data taken from a current viewing angle of the AI agent 100 during performing the i_th sub-goal. And then, the AI agent 100 may perform the i_th sub-goal according to the subsequent action plan. In case a specific target required to perform a specific sub-goal 21 among the i_th sub-goal is not detected from specific egocentric-recognizing information 23, the AI agent 100 may select a specific candidate target having a highest similarity to the specific target among candidate targets and generate a revised sub-goal which is revised from the specific sub-goal 21 by using the specific candidate target. Herein, the specific sub-goal 21 is at least one sub-goal among the i_th sub-goal. And then, the AI agent 100 may perform the specific sub-goal 21 by using the revised sub-goal.

Further, if the specific target, to be used for performing the specific sub-goal 21, is located within the surrounding area, the AI agent 100 may establish the at least one subsequent action plan 25 corresponding to the specific sub-goal 21 by referring to the specific egocentric-recognizing information 23 and the semantic map 24. Herein, the specific egocentric-recognizing information 23 is recognized by an image perception module through an analysis of specific egocentric-recognizing image data 22.

In addition, the AI agent 100 may generate a depth map corresponding to the surrounding area by referring to space information related to the surrounding area obtained by the image perception module, and obtain all pieces of object information corresponding to each of all the objects located within the surrounding area by using the image perception module. Further, the AI agent 100 may establish the semantic map by backprojecting all the pieces of object information and the depth map 24 onto 3D world coordinates, but the scope of the present disclosure is not limited thereto.

Further, on condition that the specific target, to be used for performing the specific sub-goal 21, is located within the surrounding area, in case the AI agent 100 is going to “put” a certain knife into a certain trash can, the subsequent action plan 25 may include (i) a 1_st subsequent action plan for finding the certain trash can by referring to the specific egocentric-recognizing information 23, (ii) a 2_nd subsequent action plan for moving to the certain trash can, and (ii) a 3 rd subsequent action plan for opening a lid of the certain trash can, etc.

As state above, if the AI agent 100 recognizes the certain trash can as the specific target, the specific sub-goal 21 may be performed by the AI agent 100 without any problem.

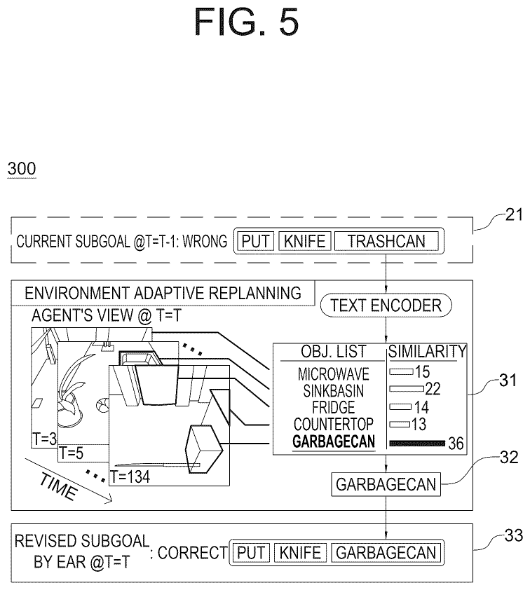

However, according to the conventional prior art, if the AI agent 100 fails to recognize the certain trash can (e.g., if the certain trash can is not located within the surrounding area), the specific sub-goal 21 may not be performed. But, in accordance with the present disclosure, the AI agent 100 may instruct the environment-adaptive replanning module 300 to select the specific candidate target (e.g., a GarbageCan) having a highest similarity to the specific target (i.e., the certain trash can) among candidate targets. The detailed explanation thereon will be explained later. Further, in order to explain an entire process of operating the environment-adaptive replanning module 300 in more detail, FIG. 5 can be referred to.

FIG. 5 is a drawing schematically illustrating a detailed configuration of the environment-adaptive replanning module 300, and processes of selecting a specific candidate target 32 having a highest similarity to a specific target among candidate targets 31 and generating a revised sub-goal 33 which is revised from a specific sub-goal 21 by using the specific candidate target 32.

By referring to FIG. 5, if it is determined that the specific target (i.e., TrashCan) for performing the specific sub-goal 21 is not located within the surrounding area by referring to the specific egocentric-recognizing information 23, the AI agent 100 may instruct the environment-adaptive replanning module 300 to perform text embedding on a specific name of the specific target and each of candidate names corresponding to each of the candidate targets 31 by using the text encoder. Herein, the candidate targets 31 may be selected by referring to the specific egocentric-recognizing information 23 and multiple pieces of previous egocentric-recognizing information acquired before the AI agent 100 performs the specific sub-goal 21. Herein, the candidate targets 31 are multiple pieces of information on objects recognized as being located within the surrounding area. For example, the AI agent 100 may select at least some of the objects, recognized by the image perception module before performing the specific sub-goal 21, as candidate targets 31 (e.g., Microwave, SinkBasin, Fridge, CounterTop, GarbageCan etc.). And then, the AI agent 100 may instruct the environment-adaptive replanning module 300 to perform text embedding on a specific name (i.e., TrashCan) of the specific target and each of candidate names corresponding to each of the candidate targets 31 by using a text encoder, thereby generating an embedded specific name and each of embedded candidate names.

In addition, the environment-adaptive replanning module 300 may calculate degrees of similarity between the embedded specific name and each of the embedded candidate names and select the specific candidate target 32 (i.e., GarbageCan) having a highest degree of similarity to the specific target by referring to the degrees of similarity between the embedded specific name and each of the embedded candidate names. Herein, the degrees of similarity between the embedded specific name and each of the embedded candidate names may be calculated by using a formula of cosine similarity, but the scope of the present disclosure is not limited thereto. That is, various formulas well known to those skilled in the art may be used.

The degrees of similarity between the embedded specific name and each of the embedded candidate names, calculated by using the formula of cosine similarity, can be defined as follows:

$${V}^{*} = {arg}_{{V}_{i}} max {S}_{c} ( Enc ( {O}_{k} ) , Enc ( {V}_{i} )$$

Herein, Enc(·) may denote the text encoder, Oₖ may denote the specific target, Vᵢ may denote the candidate targets recognized by the image perception module, and S_{c} may denote the cosine similarity between the embedded specific name and each of the embedded candidate names.

As state above, in case the specific candidate target 32 is selected, the AI agent 100 may generate a revised sub-goal 33 by replacing the specific target already inserted into the specific sub-goal 21 with the specific candidate target 32, and thus perform the specific sub-goal 21 by using the revised sub-goal 33. However, although it has been explained that the specific target is the “TrashCan”, but the scope of the present disclosure is not limited thereto. For example, other targets (e.g., “Knife”, “Potate”, or “CounterTop” etc.) may also be the specific target to be inserted into the 1_st sub-goal target holder as the 1_i-th sub-goal target or the 2_nd sub-goal target holder as the 2_i-th sub-goal target.

The present disclosure has an effect of instructing the multi-modal planning module to (i) select z training data from a plurality of training data stored in a training data set, wherein each of the training data is comprised of each of natural language instructing data for training and each of surrounding image data for training, (ii) calculate degrees of similarity between each of the selected z training data and a current pair comprised of current natural language instructing data and current surrounding image data, (iii) determine k training data having TOP k degrees of similarity to the current pair among the selected z training data, (iv) acquire k natural language instructing data for training included in the k training data, and (v) generate an initial action plan, including a 1_st sub-goal to an n_th sub-goal, to be used for performing a current task by using the k natural language instructing data for training.

The present disclosure has another effect of (i) establishing at least one subsequent action plan for the i_th sub-goal by referring to the i_th egocentric-recognizing information and a semantic map corresponding to a surrounding area, wherein the i_th egocentric-recognizing information is acquired by analyzing the i_th egocentric-image data, (ii) performing the i_th sub-goal according to the subsequent action plan, wherein, in case the specific target required to perform the specific sub-goal which is at least one of the i_th sub-goal is not detected from the specific egocentric-recognizing information, the AI agent selects the specific candidate target having a highest similarity to the specific target among candidate targets, and generates the revised sub-goal which is revised from the specific sub-goal by using the specific candidate target, and (iii) allowing the specific sub-goal to be performed by using the revised sub-goal.

The embodiments of the present invention as explained above can be implemented in a form of executable program command through a variety of computer means recordable to computer readable media. The computer readable media may include solely or in combination, program commands, data files, and data structures. The program commands recorded to the media may be components specially designed for the present invention or may be usable to a skilled human in a field of computer software. Computer readable media include magnetic media such as hard disk, floppy disk, and magnetic tape, optical media such as CD-ROM and DVD, magneto-optical media such as floptical disk and hardware devices such as ROM, RAM, and flash memory specially designed to store and carry out program commands. Program commands include not only a machine language code made by a complier but also a high level code that can be used by an interpreter etc., which is executed by a computer. The aforementioned hardware device can work as more than a software module to perform the action of the present invention and they can do the same in the opposite case.

As seen above, the present disclosure has been explained by specific matters such as detailed components, limited embodiments, and drawings. They have been provided only to help more general understanding of the present invention. It, however, will be understood by those skilled in the art that various changes and modification may be made from the description without departing from the spirit and scope of the disclosure as defined in the following claims.

Accordingly, the thought of the present disclosure must not be confined to the explained embodiments, and the following patent claims as well as everything including variations equal or equivalent to the patent claims pertain to the category of the thought of the present disclosure.

What is claimed is:

1. A method for performing at least one task according to a FLARE model including a multi-modal planning module and an environment-adaptive replanning module, comprising steps of:
(a) in response to acquiring current natural language instructing data to be used for performing a current task, (i) collecting, by an AI agent, current surrounding image data from a surrounding area of the AI agent and (ii) instructing, by the AI agent, the multi-modal planning module to (ii_1) select z training data from a plurality of training data stored in a training data set, wherein the z is an integer greater than or equal to 1, wherein each of the training data includes each of natural language instructing data for training and each of surrounding image data for training, (ii_2) calculate degrees of similarity between each of the selected z training data and a current pair comprised of the current natural language instructing data and the current surrounding image data, (ii_3) determine k training data having TOP k degrees of similarity to the current pair among the selected z training data, wherein the k is an integer greater than or equal to 1 and less than or equal to the z, and (ii_4) acquire k natural language instructing data for training included in the k training data;
(b) instructing, by the AI agent, the multi-modal planning module to generate an initial action plan, including a 1_st sub-goal to an n_th sub-goal, to be used for performing the current task by using the k natural language instructing data for training; and
(c) (i) establishing, by the AI agent, at least one subsequent action plan for an i_th sub-goal by referring to i_th egocentric-recognizing information and a semantic map corresponding to the surrounding area, wherein the i is an integer of from 1 to the n, wherein the i_th egocentric-recognizing information is acquired by analyzing i_th egocentric-image data that is image data taken from a current viewing angle of the AI agent during performing the i_th sub-goal, (ii) performing, by the AI agent, the i_th sub-goal according to the subsequent action plan, wherein, in case a specific target required to perform a specific sub-goal is not detected from specific egocentric-recognizing information, the AI agent selects a specific candidate target having a highest similarity to the specific target among candidate targets, wherein the specific sub-goal is at least one sub-goal among the i_th sub-goal, and generates a revised sub-goal which is revised from the specific sub-goal by using the specific candidate target, and (iii) allowing, by the AI agent, the specific sub-goal to be performed by using the revised sub-goal.

2. The method of claim 1, wherein, at the step of (c), the AI agent selects the candidate targets by referring to the specific egocentric-recognizing information and multiple pieces of previous egocentric-recognizing information, wherein the multiple pieces of the previous egocentric-recognizing information are acquired before the AI agent performs the specific sub-goal, and wherein the candidate targets are multiple pieces of information on objects recognized as being located within the surrounding area.

3. The method of claim 2, wherein, at the step of (c), the AI agent instructs the environment-adaptive replanning module to (i) perform text embedding on a specific name of the specific target and each of candidate names corresponding to each of the candidate targets by using a text encoder, thereby generating an embedded specific name and each of embedded candidate names, (ii) calculate degrees of similarity between the embedded specific name and each of the embedded candidate names, and (iii) select the specific candidate target having a highest degree of similarity to the specific target by referring to the degrees of similarity between the embedded specific name and each of the embedded candidate names.

4. The method of claim 1, wherein, at the step of (a), the AI agent instructs the multi-modal planning module to (i) execute a 1_st sub-process of (i_1) performing text embedding on the current natural language instructing data and each of z natural language instructing data for training included in each of the z training data by using a text encoder, thereby generating embedded current natural language instructing data and each of embedded z natural language instructing data for training and (i_2) calculating 1_st degrees of cosine similarity between the embedded current natural language instructing data and each of the embedded z natural language instructing data for training, (ii) execute a 2_nd sub-process of (ii_1) performing image embedding on the current surrounding image data and each of z surrounding image data for training included in each of the z training data by using an image encoder, thereby generating embedded current surrounding image data and each of embedded z surrounding image data for training and (ii_2) calculating 2_nd degrees of cosine similarity between the embedded current surrounding image data and each of the embedded z surrounding image data for training, and (iii) generate the degrees of similarity between each of the selected z training data and the current pair by calculating degrees of multi-modal similarity, wherein the degrees of multi-modal similarity are acquired by applying each of weights to each of the 1_st degrees of cosine similarity and the 2_nd degrees of cosine similarity and then by normalizing 1_st weighted degrees of cosine similarity and 2_nd weighted degrees of cosine similarity.

5. The method of claim 1, wherein, at the step of (b), the AI agent instructs the multi-modal planning module to (i) generate a prompt including at least one main-goal corresponding to the current natural language instructing data by referring to the k natural language instructing data for training and an expert daemon, (ii) transmit the prompt to a large language model (LLM), thereby allowing the prompt to go through in-context learning by the large language model, and (iii) generate the 1_st sub-goal to the n_th sub-goal by repeating a sub-process of inserting at least some of an i_th sub-goal action, a 1_i-th sub-goal target, and a 2_i-th sub-goal target into an i_th sub-goal frame to thereby generate the i_th sub-goal, wherein the i_th sub-goal frame is configured to include a sub-goal action holder, a 1_st sub-goal target holder, and a 2_nd sub-goal target holder, wherein the i_th sub-goal action for performing an i_th sub-action plan corresponding to the i_th sub-goal is capable of being inserted into the sub-goal action holder, and wherein the 1_i-th sub-goal target and the 2_i-th sub-goal target for performing the i_th sub-action plan are capable of being inserted into each of the 1_st sub-goal target holder and the 2_nd sub-goal target holder.

6. An AI agent for performing at least one task according to a FLARE model including a multi-modal planning module and an environment-adaptive replanning module, comprising:
at least one memory that stores instructions; and
at least one processor configured to execute the instructions to perform processes of: (I) in response to acquiring current natural language instructing data to be used for performing a current task, (i) collecting current surrounding image data from a surrounding area of the AI agent and (ii) instructing the multi-modal planning module to (ii_1) select z training data from a plurality of training data stored in a training data set, wherein the z is an integer greater than or equal to 1, wherein each of the training data includes each of natural language instructing data for training and each of surrounding image data for training, (ii_2) calculate degrees of similarity between each of the selected z training data and a current pair comprised of the current natural language instructing data and the current surrounding image data, (ii_3) determine k training data having TOP k degrees of similarity to the current pair among the selected z training data, wherein the k is an integer greater than or equal to 1 and less than or equal to the z, and (ii_4) acquire k natural language instructing data for training included in the k training data; (II) instructing the multi-modal planning module to generate an initial action plan, including a 1_st sub-goal to an n_th sub-goal, to be used for performing the current task by using the k natural language instructing data for training; and (III) (i) establishing at least one subsequent action plan for an i_th sub-goal by referring to i_th egocentric-recognizing information and a semantic map corresponding to the surrounding area, wherein the i is an integer of from 1 to the n, wherein the i_th egocentric-recognizing information is acquired by analyzing i_th egocentric-image data that is image data taken from a current viewing angle of the AI agent during performing the i_th sub-goal, (ii) performing the i_th sub-goal according to the subsequent action plan, wherein, in case a specific target required to perform a specific sub-goal is not detected from specific egocentric-recognizing information, the processor selects a specific candidate target having a highest similarity to the specific target among candidate targets, wherein the specific sub-goal is at least one sub-goal among the i_th sub-goal, and the processor generates a revised sub-goal which is revised from the specific sub-goal by using the specific candidate target, and (iii) allowing the specific sub-goal to be performed by using the revised sub-goal.

7. The AI agent of claim 6, wherein, at the process of (III), the processor selects the candidate targets by referring to the specific egocentric-recognizing information and multiple pieces of previous egocentric-recognizing information, wherein the multiple pieces of the previous egocentric-recognizing information are acquired before the AI agent performs the specific sub-goal, and wherein the candidate targets are multiple pieces of information on objects recognized as being located within the surrounding area.

8. The AI agent of claim 7, wherein, at the process of (III), the processor instructs the environment-adaptive replanning module to (i) perform text embedding on a specific name of the specific target and each of candidate names corresponding to each of the candidate targets by using a text encoder, thereby generating an embedded specific name and each of embedded candidate names, (ii) calculate degrees of similarity between the embedded specific name and each of the embedded candidate names, and (iii) select the specific candidate target having a highest degree of similarity to the specific target by referring to the degrees of similarity between the embedded specific name and each of the embedded candidate names.

9. The AI agent of claim 6, wherein, at the process of (I), the processor instructs the multi-modal planning module to (i) execute a 1_st sub-process of (i_1) performing text embedding on the current natural language instructing data and each of z natural language instructing data for training included in each of the z training data by using a text encoder, thereby generating embedded current natural language instructing data and each of embedded z natural language instructing data for training and (i_2) calculating 1_st degrees of cosine similarity between the embedded current natural language instructing data and each of the embedded z natural language instructing data for training, (ii) execute a 2_nd sub-process of (ii_1) performing image embedding on the current surrounding image data and each of z surrounding image data for training included in each of the z training data by using an image encoder, thereby generating embedded current surrounding image data and each of embedded z surrounding image data for training and (ii_2) calculating 2_nd degrees of cosine similarity between the embedded current surrounding image data and each of the embedded z surrounding image data for training, and (iii) generate the degrees of similarity between each of the selected z training data and the current pair by calculating degrees of multi-modal similarity, wherein the degrees of multi-modal similarity are acquired by applying each of weights to each of the 1_st degrees of cosine similarity and the 2_nd degrees of cosine similarity and then by normalizing 1_st weighted degrees of cosine similarity and 2_nd weighted degrees of cosine similarity.

10. The AI agent of claim 6, wherein, at the process of (II), the processor instructs the multi-modal planning module to (i) generate a prompt including at least one main-goal corresponding to the current natural language instructing data by referring to the k natural language instructing data for training and an expert daemon, (ii) transmit the prompt to a large language model (LLM), thereby allowing the prompt to go through in-context learning by the large language model, and (iii) generate the 1_st sub-goal to the n_th sub-goal by repeating a sub-process of inserting at least some of an i_th sub-goal action, a 1_i-th sub-goal target, and a 2_i-th sub-goal target into an i_th sub-goal frame to thereby generate the i_th sub-goal, wherein the i_th sub-goal frame is configured to include a sub-goal action holder, a 1_st sub-goal target holder, and a 2_nd sub-goal target holder, wherein the i_th sub-goal action for performing an i_th sub-action plan corresponding to the i_th sub-goal is capable of being inserted into the sub-goal action holder, and wherein the 1_i-th sub-goal target and the 2_i-th sub-goal target for performing the i_th sub-action plan are capable of being inserted into each of the 1_st sub-goal target holder and the 2_nd sub-goal target holder.
